(19) United States
(12) Patent Application Publication
(10) Pub. No.: US 2010/0060733 A1
(43) Pub. Date: Mar. 11, 2010

(54) REMOTE SURVEILLANCE SYSTEM

(76) Inventor: BALAJI LAKSHMANAN, CHENNAI (IN)

Correspondence Address: BALAJI LAKSHMANAN, 52D, Srichakra Apts, 47th Street, Ashok Nagar, CHENNAI, TAMIL NADU, 600083, omitted

(21) Appl. No.: 12/554,887

(22) Filed: Sep. 5, 2009

Related U.S. Application Data
(60) Provisional application No. 61/094,884, filed on Sep. 6, 2008.

(51) Int. Cl. H04N 7/18

(52) U.S. Cl. 348/143; 348/E07.085

(57) ABSTRACT

The present invention provides apparatus and methods for providing a wired and wireless camera surveillance and control system. The system comprises a high sensitivity camera with enhanced infrared response, an infrared light surveillance. The system also comprises light source which can be operated using a switch. The system combines optimized controller which can control the camera and the light source. The apparatus contains a receiver and computer or recording device and display device where the signals obtained are recorded using computer and recording device or viewed in the display device and further observed as decision support system. The nature of the system is transparent to the user due to the integrated automated control of the system and allows reduced power consumption making the system very suitable for a wired or wireless remote, self contained system that draws power from the ambient environment.

### FIELD OF THE INVENTION

The field of the invention relates generally to surveillance equipment and more particularly, to a surveillance device that can be used to gather video data through camera and light source and transmit the data to a remote location for monitoring.

### BACKGROUND OF THE INVENTION

Nowadays it has been very popular for surveillance cameras to be able to record video during surgeries and other important events. At night there is little or no visible natural light sufficient to record visible light images, and it is often undesirable or impractical to provide artificial light at night or over great distances and areas in order to enable visible light images to be recorded. The continuous lighting of a large area by artificial means can be prohibitively expensive, and may not be possible at all in remote areas. With infrared illumination, it is possible to obtain satisfactory images of a scene at night, and without alerting an intruder. Digital cameras, both video and still, have been very popular nowadays. People can take the advantages of digital cameras to record favorite scenes and pictures and share them with others. A traditional camera usually requires a person to act as the photographer to hold and operate the camera to take video or still pictures on other people or subjects. In the case where one would like to take video or pictures of him, he would need to make an estimate of the focus of the camera lens and then use a remote control unit of the camera to record. Oftentimes, such an estimate is very rough and the subject in the resulting video or picture is not in a desired position. Further, it involves a number of adjustments in order to obtain acceptable video or pictures. Making the adjustments back and forth gives much inconvenience and hassles to users such that this feature of the camera is rarely used by many users.

Therefore, there is a need for an improved camera that allows a user to be able to conveniently and accurately record video or pictures of the user himself.

The relevant prior art methods, which will deal with camera with light source which uses a recording device are as follows:

US Patent Application No. 20060139459 provides an improved digital camera that enables a user to conveniently and accurately record video or pictures of the user himself. In one embodiment of the invention, a digital camera comprises a camera body and a display panel detachably connected to the camera body. The display panel includes a remote control circuit that is configured to wirelessly operate the camera, so that a user can record any contents seen in the display panel. In another embodiment of the invention, the camera further includes a motor attached to the camera body, and the remote control circuit controls the motor to focus the lens on a desired subject. The remote control circuit includes a wireless communication interface that supports at least one of the following protocols: Bluetooth, Zigbee, IEEE 802.11 and infrared. The invention is applicable to both digital video and still cameras.

US Patent Application No. 20030093805 discloses a dual camera surveillance and control system comprising a high sensitivity mono camera with enhanced infrared response, an infrared illuminator array for zero ambient light surveillance, and a color camera that does not need to be enhanced in the infra red spectrum. The system also comprises ambient light level sensing, video signal switching technology and power conversion circuitry. The system combines optimized mono imaging under low or no light conditions with optimized color rendered imaging during high ambient light conditions, with both achieving high quality focus. The dual camera nature of the system is transparent to the user due to the integrated automated control of the system, and allows reduced power consumption, making the system suitable for a wireless, remote, self-contained system that draws power from the ambient environment.

US Patent Application No. 20060156361 describes a remote viewing system for providing video and/or audio surveillance of an entry or doorway of a building. The system is provided within the panels of the entry or doorway door. A video camera is positioned within the panels to obtain video images of the entryway or doorway and to transmit them via Bluetooth wireless connection to a remote viewing station. The Wireless driver for the camera can be located in or adjacent to the door panel. Video and audio data can be transmitted from the driver to any of a variety of Bluetooth enabled electronic devices, including PCs, PDAs, cell phones, and the like.

US Patent Application No. 20070013513 reveals a surveillance system utilizing existing street lighting equipment. surveillance units include a small camera and a wireless transceiver and a connector that allows the surveillance units to plug into an existing outdoor light in the place of the outdoor lights' photo cells. In this preferred embodiment communication between the lights and the cellular station is at frequencies of about 2.4 GHz and uses the 802.11b protocol that permits transmission of data at up to 11 million bits per second or the 802.11g protocol that permits transmission of data at up to 54 million bits per second. The cellular stations then communicates with the central monitoring station at a frequency range of 71-76 GHz and 81 to 86 GHz that permits transmission of data at about 1.0 billion bits per second. In an example system, with 1,000 surveillance cameras (each camera unit plugged into the photocell receptacle of a street light), 100 camera units communicate with each of 10 cellular stations and the 10 cellular stations communicate with a single central monitoring station.

US Patent Application No. 20070155208 claims a system for controlling medical devices, wherein this system can comprise a device having at least one wireless or cellular based communication module. The module can be in the form of a GPRS module associated with a SIM card, or a CDMA module. The SIM card can be adapted such that it contains additional memory for storing a program for controlling the device or the system. Multiple cellular communication modules can also be installed in this system. Additional communication modules such as wireless modules including but not limited to Bluetooth, IRDA, RF, or any other wireless module can also be incorporated into the system. Wired modules can also be used, for example these wired modules can be RS-232 modules, USB, Serial adapters, phone and fax modem. Other modules can include audio modules such as speaker and microphone jacks, and video modules such as a camera for processing video readings. All of these components can be installed on a first side of a motherboard, which is disposed inside of a housing. The other side of the motherboard can have particular functional elements installed thereon. These functional elements can include a flow meter, and/or a electromechanical valve. All of these components can be controlled by one or more processor coupled to the motherboard. When this device is coupled to an ordinary PAP machine, such as a CPAP machine, it can be used to turn an ordinary PAP machine into an auto-adjust PAP machine or a BiPAP machine.

US Patent Application No. 20070254640 describes about a system, method, and device for remotely controlling the camera functions of a mobile camera phone. The mobile camera phone and another device are communicable with one another using the Bluetooth™ protocol. Each includes a Bluetooth module that establishes a wireless connection with one another such that data and instructions can be exchanged. The other device receives and displays data representative of the mobile camera phone's viewfinder. A camera application is coupled with the Bluetooth module for establishing a master/slave relationship with a corresponding camera application in the mobile camera phone. The other device sends camera control commands to the mobile camera phone wherein the camera control commands can manipulate camera settings, take a picture, and dispose of the resultant picture. The other device further includes a user interface coupled with the display that provides a means of inputting data to manipulate the camera application.

US Patent Application No. 20040233284 disclosed that the present invention provides apparatus and methods for providing visual information about a subject of interest. Specifically, the apparatus of the present invention includes a camera and light source for location at a point of interest. Pictures and/or video from the camera is transmitted to a remote location where it may be viewed by an interested party such that the user is not required to be in the vicinity of the area of interest to collect observations. The apparatus may use wireless communication, such as satellite, RF, and/or IR technology to transmit the data from the camera to the remote location. Further, the apparatus may include sensors for sensing characteristics of the environment surrounding. These environmental characteristics can be transmitted to the remote location or used triggering operation of the camera.

US Patent Application No. 20020076217 reveals an information system for communication between a digital camera and bidirectional device that is located in proximity to a photographic site is disclosed. In the absence of the digital camera, the bidirectional device may provide communication with a personal digital communication device (PDCD) carried by the photographer. The digital camera may transmit preferences and camera data to the bidirectional device so that customized information, prepared by an information provider, may be automatically transmitted to the digital camera or PDCD or, via the Internet, to the photographer's e-mail address. A standardized photographic identification data packet (PIDDP) may be defined for use by the digital camera or the PDCD, for communication with the bidirectional device. The PIDDP may be transmitted by means of radio frequency, infrared, Bluetooth enabled transmission, or any other transmission method. The information system is implemented by a method for automatically recording information related to a photograph into the communication device in a digital camera or PDCD.

US Patent Application No. 20050286883 discloses an electronic device with a camera function, an electronic device, a photographing control method, a photographing control program, and a processor in which a preventive function to block inappropriate photographing such as spy shots is enhanced are provided. A photographing reporting section (54, 54A, 54B) issues a reporting information for photographing; an information detecting section (58, 58A, 58B) detects this reporting information; and a judging section (image output judging section 60) judges whether or not the photographing is permitted, whether or not an image is stored, and whether or not the image is altered by using the reporting information detected at the information detecting section. Further, a transmitting section (Bluetooth wireless transmitting/receiving section 100 of mobile phone 40A) transmits in synchronization with the shutter operation a reporting information requesting photographing permission to an opposite electronic device (mobile phone 40B); a receiving section (Bluetooth wireless transmitting/receiving section 100) receives a notifying information representing whether or not the photographing is permitted from the opposite electronic device (mobile phone 40B); and a judging section (image output judging section 108) judges whether or not the photographing is permitted by using the notifying information.

However the purpose and methodology of the above inventions that are part of prior art do not envisage the video recording to be worn or attached to the head of the person that to be performed wired or wirelessly without any interruption to other persons. They also do not provide the steps and tools to go about the same. The present invention differs from the existent prior art in that it uses a component which is a combination of wired and wireless camera and a light source which can be operated, using a switch. This component can be worn/attracted/to the head of a person/doctors/dentist or security person.

It will be apparent to those skilled in the art that the objects of this invention have been achieved by providing the above composition of parts. Various changes may be made in and without departing from the concept of the invention. Further, features of some stages disclosed in this application may be employed with features of other stages. Therefore, the scope of the invention is to be determined by the terminology of the following claims and the legal equivalents thereof.

### SUMMARY OF THE INVENTION

This invention may be summarized, at least in part, with reference to its objects. The primary object of this invention is to use a wired or wireless camera and a light source which can be operated using a switch.

Another object of the invention is to minimize the power consumption and it can used for security purpose.

Another object of the invention is to provide a optimized controller which can control the camera and the light source.

Yet another object of the present invention is to zoom the camera in and out and control the intensity of the light source.

Another object of the invention is to provide a receiver and computer or a recording apparatus with a display device where the signals obtained is recorded using computer.

Another object of the invention is in which the recording device or viewed in the display device and it can be used for further observation or as decision support system.

These and other objects of the present invention will be more readily apparent when considered in reference to the following description and when taken in conjunction with the accompanying drawings.

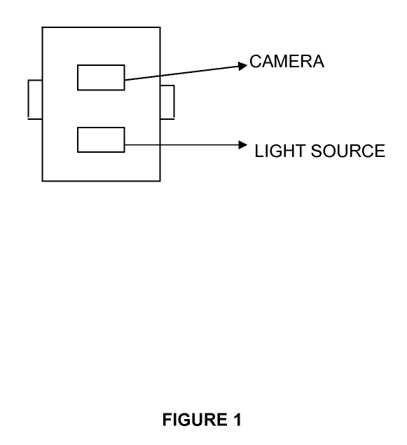

FIG. 1 is a box diagram that illustrates the camera and light source components.

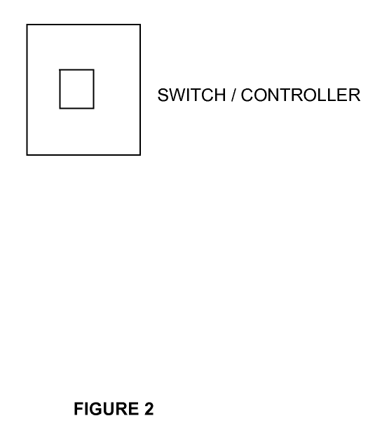

FIG. 2 is a box diagram that illustrates the switch or controller components.

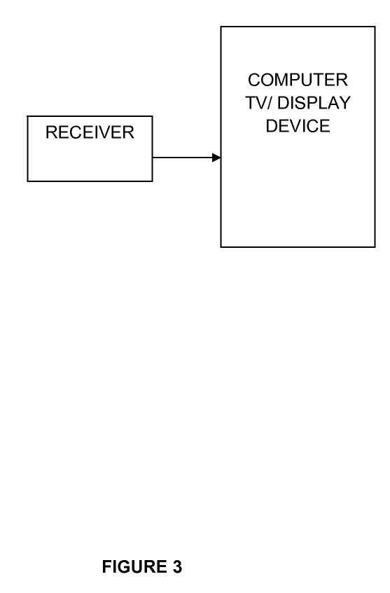

FIG. 3 is a box diagram that illustrates the receiver, computer or TV or any display device where the recording is done.

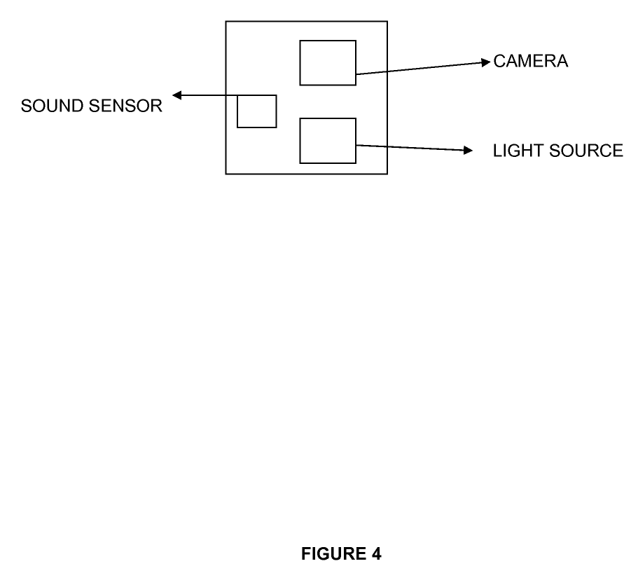

FIG. 4 is a is a box diagram that illustrates the integrating component with sound sensor.

### DETAILED DESCRIPTION OF THE INVENTION

The following description is presented to enable any person skilled in the art to make and use the invention, and is provided in the context of particular applications of the invention and their requirements. The present invention can be configured as follows:

Remote surveillance system is specially developed to deal with methods for providing a wired and wireless camera surveillance and control system. The system comprises a high sensitivity camera with enhanced infrared response, an infrared light surveillance The system also comprises light source which can be operated using a switch. The system combines optimized controller which can control the camera and the light source. As explained in the summary the present invention comprises a camera which is optimized for wavelength of light. This particular camera is attached to the heads of the user through a belt like structure.

This camera also consists of an infrared-filtered (color) lens 205 with mechanism adjustments for field of view 206 and focus 207. Rotation of these adjustments in the plane of the camera both frames and focuses the viewed area. Twisting these adjustments in the orthogonal plane locks the chosen settings.

Ambient light sensor detecting low light level causes the system to switch to camera mode and activates the appropriate degree of illumination.

The first embodiment of the present invention is a combination of wired and wireless camera and a light source which can be operated using a switch, and this particular component can be worn to the head of a person more particularly doctors, dentists and security people.

The second embodiment of the present invention uses a optimized controller which can control the light source and camera and it can be a ordinary switch. The next embodiment of the present invention comprises in case if it is a controller it can be used to move the camera and light source either up and down or right and left and it can also be used to zoom the camera in and out and control the intensity of the light source.

Another embodiment of the invention contains receiver and computer and a recording device and display device whereby the video signals obtained is recorded using computer and a recording device and or viewed in the display device and used for further observation or as decision support system especially doctors and dentists. Similarly the invention can be used instead of the first embodiment and it can be used for security purpose and it can either be attached to animals and humans for efficient security with minimizing the power requirement.

Various modifications to the disclosed embodiments will be readily apparent to those skilled in the art and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

What is claimed is:

1. A remote surveillance system comprising of an apparatus and method for providing a wired and wireless camera surveillance including a sound and video recording control system wherein the system comprises a high sensitivity camera with enhanced infrared response.

2. The remote surveillance system as claimed in claim 1 wherein the said camera is a wired or wireless camera and connected to a light source.

3. The remote surveillance system as claimed in claim 1 wherein the said invention includes a switch or may provide a optimized controller which can control said camera and said light source.

4. The remote surveillance system as claimed in claim 1 wherein the said invention uses a key to zoom said camera in and out and control the intensity of said light source.

5. The remote surveillance system as claimed in claim 1 wherein the said invention provides a receiver and computer or a recording apparatus with a display device.

6. The remote surveillance system as claimed in claim 1 wherein the video signals obtained from said camera are recorded using said computer.

7. The remote surveillance system as claimed in claim 1 wherein said video signals can be viewed as images in the display device.

8. The remote surveillance system as claimed in claim 1 wherein said video signal images viewed in the display device can be used for further observation or as decision support system.
